(19) United States
(12) Patent Application Publication
(10) Pub. No.: US 2008/0158867 A1
(43) Pub. Date: Jul. 3, 2008

(54) Structure of a flashlight

(76) Inventor: Yun-Zhao Liu, Zhongshan City (CN)

Correspondence Address: ROSENBERG, KLEIN & LEE, 3458 ELLICOTT CENTER DRIVE-SUITE 101, ELLICOTT CITY, MD, 21043, US

(21) Appl. No.: 11/647,249

(22) Filed: Dec. 29, 2006

(51) Int. Cl. F21L 4/04

(52) U.S. Cl. 362/206; 396/205

(57) ABSTRACT

A flashlight includes a main body, a light source on a front end of the main body, batteries held in the main body, a bottom cover on a tail end of the main body, and a control device for controlling brightness and frequency of flashing of the light source; the control device is secured in the bottom cover, and electrically connected to the power source, and it includes a control switch sticking out through the bottom cover; the main body houses first and second conducting plates, which are connected to two poles of the battery respectively; the main body further houses a first elastic element positioned between and electrically connected to a positive pole terminal of the control device and the first conducting plate, and a second elastic element positioned between and electrically connected to a negative pole terminal of the control device and the second conducting plate.

### BACKGROUND OF THE INVENTION

1. Field of the Invention

The present invention relates to a flashlight, more particularly one, which can be controlled to change brightness and frequency of flashing of the light source so as to satisfy the user's needs in various situations.

2. Brief Description of the Prior Art

Flashlights are usually used to provide illumination in the dark, thus allowing people to see more clearly in searching, repairing, walking or doing jobs. Therefore, flashlights are indispensable in people's daily life.

A conventional flashlight structure includes a hollow main part, a lamp shade member, a light source fitted to a front end of the hollow main part, a switch fitted on a lateral side of the hollow main part, and a bottom cover fitted over a rear end of the hollow main part. The switch is used to turn on/off the light source. And, the lamp shade member is joined to the front end of the hollow main part so as to be around the light source.

Light will be emitted from the front end of the flashlight to provide illumination when the flashlight is turned on by means of the switch. However, the flashlight can only continue shining at a fixed brightness when turned on. Furthermore, the flashlight doesn't have other functions therefore they can't attract or satisfy those people who like to buy and use multifunction products.

Therefore, it is a main object of the present invention to provide an improvement on a flashlight to overcome the above-mentioned problems.

### SUMMARY OF THE INVENTION

A preferred embodiment of a flashlight of the present invention includes a main body, a light source on a front end of the main body, batteries held in the main body, a bottom cover on a tail end of the main body, and a control device. The control device is secured in the bottom cover, and electrically connected to the power source, and it includes a control switch sticking out through a hole of the bottom cover. The main body houses first and second conducting plates, which are each connected to a respective one of two poles of the battery; the main body further houses a first elastic element positioned between and electrically connected to a positive pole terminal of the control device and the first conducting plate, and a second elastic element positioned between and electrically connected to a negative pole terminal of the control device and the second conducting plate. The control switch is used to change brightness and frequency of flashing of the light source so as to satisfy the user's needs in various situations.

### BRIEF DESCRIPTION OF THE DRAWINGS

The present invention will be better understood by referring to the accompanying drawings, wherein:

FIG. 1 is a perspective view of the present invention, and

FIG. 2 is a lateral sectional view of the present invention.

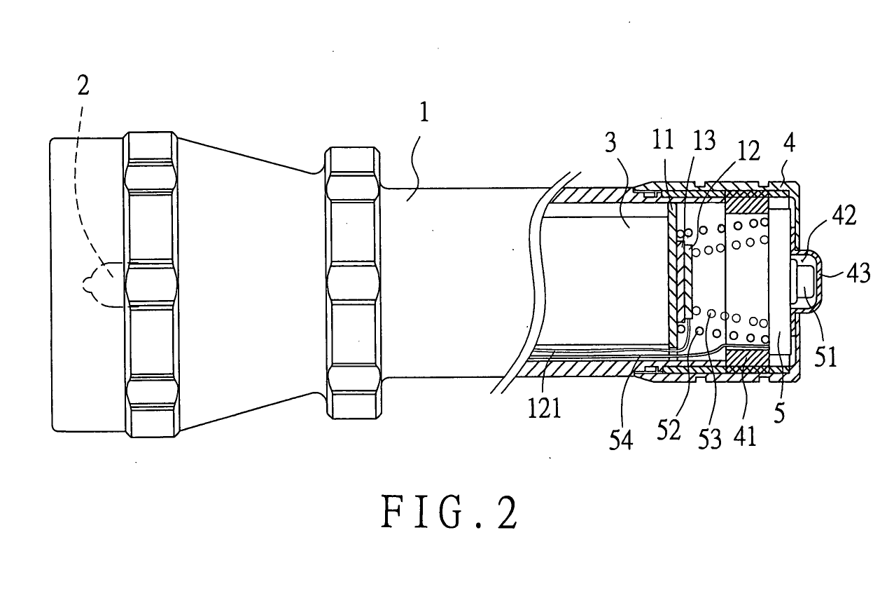

### DETAILED DESCRIPTION OF THE PREFERRED EMBODIMENTS

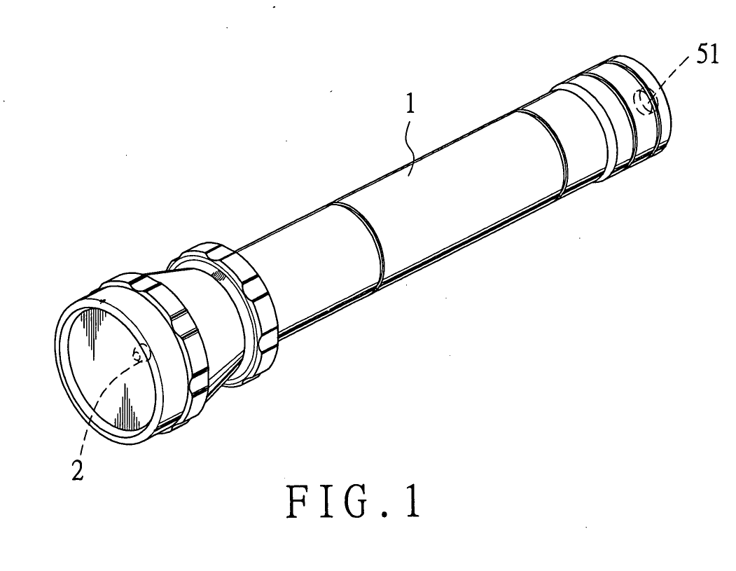

Referring to FIG. 1, a preferred embodiment of a flashlight of the present invention includes a main body 1, a light source 2, batteries 3, a bottom cover 4, and a control device 5.

The light source 2 is arranged on a front end of the main body 1, and it can be bulbs or light emitting diodes. The batteries 3 are held in the main body 1. The bottom cover 4 is positioned on a tail end of the main body 1. The control device 5 includes a microcomputer processor, and it is secured in the bottom cover 4.

The main body 1 houses a first conducting plate 11, a second conducting plate 12, and an insulating plate member 13, which is interposed between the first and the second conducting plates 11 and 12. The first conducting plate 11 is directly connected to a positive pole (not shown) of the batteries 3 while the second conducting plate 12 is connected to a negative pole (not shown) of the batteries 3 by means of a wire 121. The bottom cover 4 has installing blocks 41 therein, and the control device 5 with the microcomputer processor is held in position in the bottom cover 4 by means of the installing blocks 41.

The bottom cover 4 further has a through hole 42 thereon, and a rubber covering part 43 is positioned over the through hole 42. The control device 5 includes a control switch 51, which sticks through the through hole 42 to be covered with the rubber covering part 43 of the bottom cover 4. Furthermore, a first elastic element 52 is positioned between the first conducting plate 11 and a positive pole terminal (not shown) of the control device 5, and electrically connected to the first conducting plate 11, and the positive pole terminal of the control device 5 at two ends thereof. And, a second elastic element 53 is positioned between the second conducting plate 12 and a negative pole terminal (not shown) of the control device 5, and electrically connected to the second conducting plate 12, and the negative pole terminal of the control device 5 at two ends thereof. The control device 5 is further connected to the light source 2 by means of wires 54.

In use, the control switch 51 of the control device 5 can be pressed a certain number of times in order for the control device 5 to control the electric currents to the power source 2 such that the power source 2 continues shining at a certain brightness accordingly or flashes on and off repeatedly at a certain frequency and brightness accordingly. Or alternatively, the control switch 51 can be kept pressed for a certain length of time in order for the control device 5 to control the electric currents to the power source 2 such that the power source 2 continues shining at a certain brightness accordingly or flashes on and off repeatedly at a certain frequency and brightness accordingly.

From the above description, it can be seen that the flashlight of the present invention has an advantage over the prior art: the flashlight has the control device with the control switch, which can be pressed so as to change the brightness and frequency of flashing of the light source to satisfy the user's needs in various situations.

1. An improvement on a structure of a flashlight, comprising:
a main body,
a light source on a front end of the main body,
at least one battery held in the main body,
a bottom cover on a tail end of the main body, the bottom cover having a through hole thereon;
a control device securely positioned in the bottom cover, the control device being connected to the power source by means of wires; the control device including a control switch facing the through hole of the bottom cover; the control device having positive and negative pole terminals, whereby application of force on the control switch actuates the light source to provide (1) a constant light emission or a pulsating light emission to pattern blinking of the light source,
first and second conducting plates housed in the main body, the first and the second conducting plates being each connected to a respective one of two poles of the battery;
a first elastic element, the first elastic element being positioned between and electrically connected at two ends respectively to the positive pole terminal and the first conducting plate; and
a second elastic element, the second elastic element being positioned between and electrically connected at two ends respectively to the negative pole terminal and the second conducting plate.

2. The improvement on a structure of a flashlight as recited in claim 1, wherein the bottom cover has at least one installing block therein, and the control device is held in position in the bottom cover by means of the installing block.

3. The improvement on a structure of a flashlight as recited in claim 1, wherein the bottom cover has a rubber covering part positioned over the through hole thereof, and the control switch of the control device sticks through the through hole to be covered with the rubber covering part of the bottom cover.

4. The improvement on a structure of a flashlight as recited in claim 1, wherein the light source includes at least one bulb.

5. The improvement on a structure of a flashlight as recited in claim 1, wherein the light source includes at least one light emitting diode.
